(19) United States
(12) Patent Application Publication
(10) Pub. No.: US 2023/0150255 A1
(43) Pub. Date: May 18, 2023

(54) LIGHTWEIGHT ROTOGRAVURE PRINTING CYLINDER

(71) Applicant: MATTHEWS INTERNATIONAL CORPORATION, Pittsburgh, PA (US)

(72) Inventors: Ali TANRISEVEN, Izmir (TR); Tugba DALGICER, Izmir (TR)

(21) Appl. No.: 17/919,558

(22) PCT Filed: Jun. 24, 2021
(86) PCT No.: PCT/TR2021/050652

§ 371 Date: Oct. 18, 2022

(30) Foreign Application Priority Data
Jul. 9, 2020 (TR) 2020/10908

(51) Int. Cl. B41F 13/11; B41N 1/20

(52) U.S. Cl. CPC B41F 13/11; B41N 1/20

(57) ABSTRACT

Rotogravure cylinders used for printing on packaging materials based on the transfer of ink onto the packaging material from the printing cylinder surface with a printing technique. The lightweight rotogravure printing cylinders developed are not heavy which prevent the factors which pose an ergonomic risk in terms of occupational health and safety and also cause an increase in logistics costs. For this purpose, the wall thickness of the steel body of the cylinder is decreased.

### FIELD OF THE INVENTION

The present invention relates to an application which enables to lighten the steel body in rotogravure printing cylinders by reducing the wall thickness thereof in order to eliminate factors such as posing risks in terms of occupational health and safety as well as increasing of the logistics costs, due to the fact that rotogravure printing cylinders are heavy.

### BACKGROUND OF THE INVENTION

Rotogravure printing is a method of printing in which different colors of patterns desired to be printed on a material are applied by different printing cylinders. Basically, the steel body of the rotogravure printing cylinder consists of four main elements; seamless drawn steel tube, flange, shaft and bushing (shaft cylinder); and shaftless cylinder is comprised of seamless drawn steel tube and flange. The said cylinder, which is produced as a steel body, becomes ready for printing after copper plating, gravure and chrome plating processes in other processes. The weight of the cylinders produced as explained above varies between 85-500 kg.

Steel cylinder bodies that are used for rotogravure printing are generally produced as large structures with a hollow inner volume in the state of the art and they are generally manufactured from a heavy material, preferably from steel material, with a high wall thickness. However, even though the main interaction depends not on the pressure caused by the weight of the cylinder, but on the proximity to the surface to be printed and the pressure generated specific to the contact surface, this solution with the weight, the advantage of which has not been proven, continues in the state of the art of the method.

Generally, gravure cylinders are made of hot drawn or cold formed steel body with 0.2-1 mm thick copper layer and 6-8 micron thick chrome layer. In the surface forming processes, to create the pattern to be printed on the packing material, the copper layer is coated on the body of cylinder (e.g. steel) by using electrolysis method, engraving method, or etched chemical or electromechanical (diamond) method or electronic (laser) method. The chrome layer on the engraved cylinder protects the cylinder against the pressure applied by the scraper blade on the cylinder during printing.

Generally, the body of the cylinders is made of heavy steel which meets the required precision and small deviation requirements during printing. The preparation of the cylinders with heavy steel body used in this way is time consuming and they need to be transported between different production processes during production. By means of reducing the wall thickness of the steel body, the production phase is made safer and fewer raw materials are used, resulting in an advantage in terms of cost.

Rotogravure printing cylinders are manufactured in accordance with the demands of the users based on the technical drawings they send, and their weight varies between 85-500 kg in applications known in the state of the art. Even though there is no proven advantage of using cylinders with high wall thickness in terms of technical requirements, the use of high wall thickness and therefore heavy structures is often preferred in the printing applications sector.

The heavy weight of the cylinders causes the employees to lift heavier loads during the maintenance and repair activities carried out at the site of the user. This situation creates a direct occupational health and safety threat and can create a problem for the health of the employees. In addition, logistics costs increase due to the weight of the cylinder.

In applications known in the state of the art, the use of steel pipes with high wall thickness causes the formation of scrap after processing. The excess of steel-containing scrap causes unnecessary consumption and no protection of raw material resources.

Japanese patent application no JP2013237274, an application known in the state of the art, discloses the structure of the printing cylinder, the printing cylinder structure, the weight of which is aimed to be reduced, includes a plurality of ribs/support parts extending between the shaft passing through the center of the cylinder and the cylindrical part. The weight of the cylindrical part is decreased by reducing its wall thickness. In this reference document, the geometry of the materials placed inside the pipe for the purpose of lightening is different from the invention of the present application, and the position of the ribs are arranged parallel to the cylinder such that they will not cover the whole surface in a circular sense.

U.S. Pat. No. 3,922,772, an application known in the state of the art, discloses a method for producing parts such as printing cylinders operating at high speeds with hollow cylinders and low weight.

German patent application no DE10046559, one of the applications known in the state of the art, discloses an impression cylinder configuration having a printing surface in the form of a thin jacket with a wall thickness of less than 0.5 mm. Printing form with smaller wall thickness allows having low weight. In addition, the lighter printing form (impression cylinder) further reduces transport and storage costs.

United States patent application no US2006070540, one of the applications known in the state of the art, relates to the use of spacer sleeves in the wall thickness of the printing cylinders.

Japanese patent application no JPH02243344, one of the applications known in the state of the art, discloses improving the printing application by means of expanding the wall thickness of the printing cylinder. It is aimed to provide high strength and low weight with the layers used to increase the wall thickness.

### SUMMARY OF THE INVENTION

The objective of the invention is to prevent factors which pose an ergonomic risk in terms of occupational health and safety and which also cause an increase in logistics costs, thanks to the low weight of the rotogravure printing cylinders.

### DETAILED DESCRIPTION OF THE INVENTION

“Lightweight Rotogravure Printing Cylinder” developed in order to fulfill the objectives of the present invention is illustrated in the accompanying figures, in which:

FIG. 1 is the exploded view of the printing cylinder of the present invention.

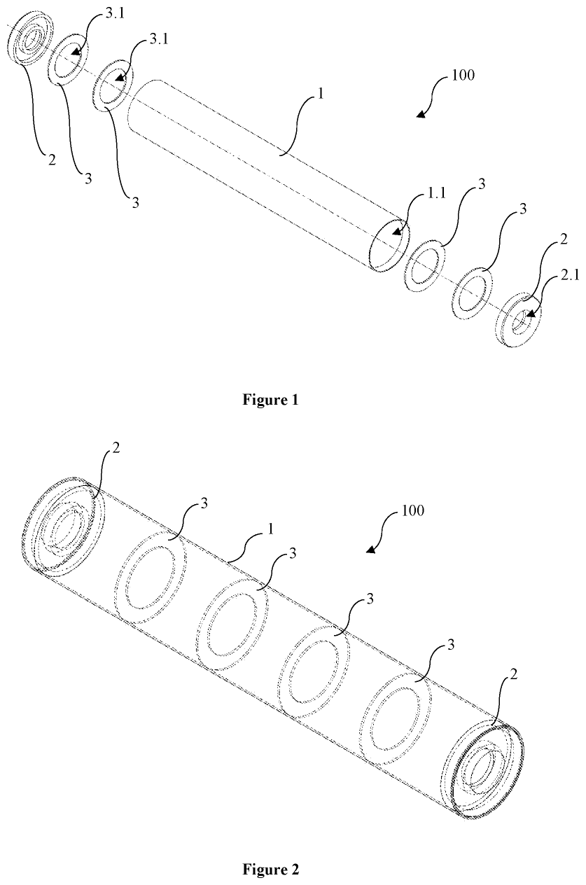

FIG. 2 is the view of internal structure of the printing cylinder of the present invention.

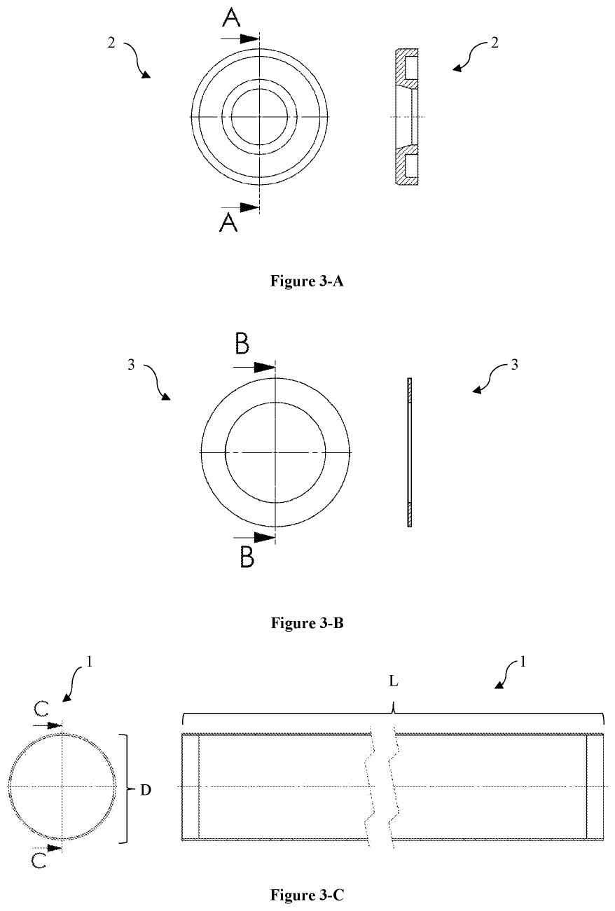

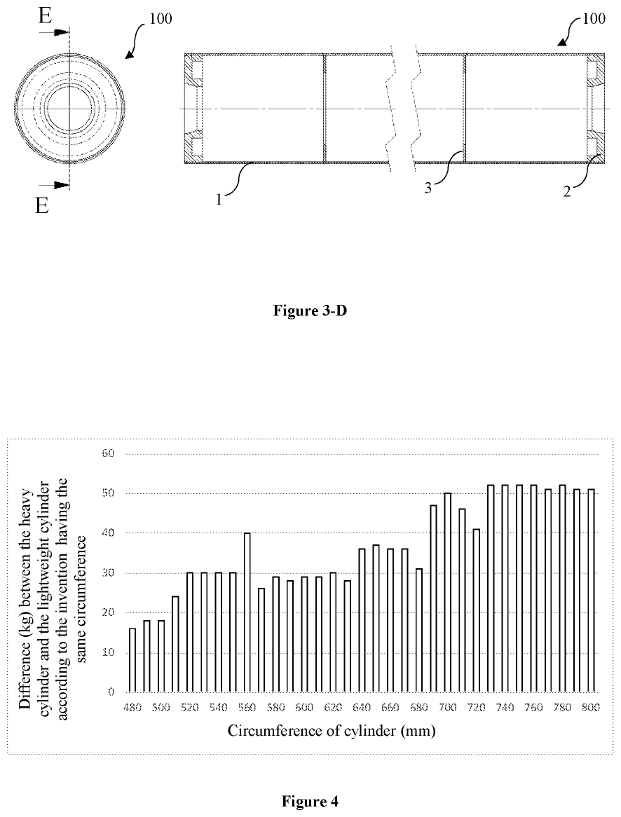

FIG. 3 is the front view and sectional view of the parts of the printing cylinder of the present invention
A. is the front view of the cover piece (flange) and the illustration of A-A cross-section in this front view.
B. is the front view of the rib piece and the illustration of B-B cross-section in this front view.
C. is the front view of the body piece and the illustration of C-C cross-section in this front view.
D. is the front view of the whole structure of the printing cylinder of the present invention and the illustration of E-E cross-section in this front view.

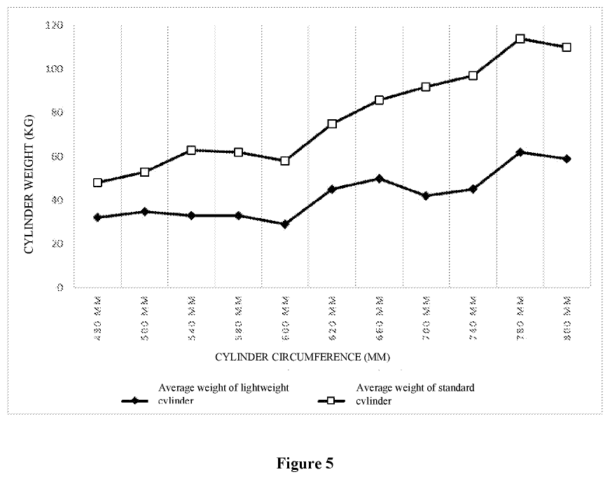

FIG. 4 is a graphical representation of the difference between the weight of the lightweight printing cylinder of the present invention and a standard printing cylinder having similar circumferences.

FIG. 5 is a graphical representation of the comparison of the weight changes in similar circumferences of the lightweight printing cylinder of the present invention and a standard printing cylinder.

The components shown in the figures are each given reference numbers as follows:
100. Lightweight rotogravure printing cylinder
   1. Body
      1.1. Inlet
   2. Cover
      2.1. Shaft opening
   3. Rib
      3.1. Shaft opening

The lightweight rotogravure printing cylinder (100) of the present invention comprises
at least one body (1) which has a hollow cylindrical form and inlets (1.1) at both ends of the lateral surface of the cylindrical form that are open so as to allow access to the inner volume,
at least one cover (2) which enables to close the open inlets (1.1) of the cylindrical body (1) and to form a closed cylindrical form, and has at least one shaft opening (2.1) that allows grasping the shaft, which enables the cylindrical body (1) to be placed on the printing machine and rotational movement to be transferred therethrough, when it is passed through the center of the cylindrical body (1),
at least one rib (3) in the form of a circular plate which is spaced apart along the length of the cylindrical body (1) extending between the covers, and enables the middle section of the cylindrical body (1) remaining between the covers (2) to be supported from its inner surface, and has a shaft opening (3.1) of a size that allows the shaft to pass through the center thereof.

In one embodiment of the invention, the wall thickness of the steel plate material used to form the body (1) is 3.5-7.5 mm. The body (1) can be steel or its derivatives, as well as it can be composite-based materials, rigid polymer structures.

In one embodiment of the invention, the distance (L) between two consecutive ribs (3) is adjusted such that it will be in the range of minimum 1 cylinder diameter (D) and maximum 2 cylinder diameters (D):

D≤L≤2D

In one embodiment of the invention, the ribs (3) are positioned such that there will be at least 2 of them for each 1 meter of length along the length of the cylindrical body (1).

In one embodiment of the present invention, at least 3 ribs (3) are positioned at equal intervals inside the cylindrical body (1).

In one embodiment of the invention, the wall thickness of the rib (3) enabling the cylindrical body (1) to be supported from its inner surface is maximum 5 mm.

In one embodiment of the invention, the ribs (3) are welded to the inner walls of the cylindrical body (1) by circumferential welding method (Mig-Mag method). Metal Inert Gas (MIG) welding method is a metal arc welding carried out under the shielding effect of helium, argon gases and gases formed upon mixture of these gases. In this type of welding, melting occurs when the arc is formed between the workpiece and the electrode. The electrode is fed to the welding area in the form of a coil wire with controlled feeding speed. The shielding gas is blown through the torch, creating a gas layer between the molten bath and the air. There are two reasons for preferring the said welding method: It is easy to apply and advantageous in terms of cost.

The present invention relates to rotogravure cylinders used for printing on packaging materials, and it is based on the transfer of ink onto the packaging material from the printing cylinder surface with a printing technique. Thanks to the fact that the lightweight rotogravure printing cylinders (100) developed within the scope of the invention are not heavy, it is aimed to prevent the factors which pose an ergonomic risk in terms of occupational health and safety and also cause an increase in logistics costs. For this purpose, the wall thickness of the steel body (1) of the cylinder is decreased.

It is ensured that the lightweight rotogravure printing cylinders (100) of the invention, which provide a similar result in terms of printing quality, are lighter 1-75% by weight (preferably in the range of 50-60%) compared to the state of the art applications. In addition, the production of cylindrical body (1) with low wall thickness, which is carried out for the purpose of achieving light weight, enables to use less material.

Within the scope of the invention, the wall thickness of the steel plate material used to form the cylindrical body (1), the cylindrical tube-shaped structure, is selected to be 3.5-7.5 mm. This thin wall thickness provides a significant advantage compared to the current applications at the purchasing stage, as it allows the product of the present invention to be obtained by supplying the steel-containing and scrapped raw material in the closest related circumference. In the current situation, although the type of cylinder varies according to the circumference/length and technical drawing of the customer, steel pipes with an average wall thickness of 24-30 mm are used. In this context, the amount of rough cut is less and at the same time, the time of the raw material external turning process and turning cutting insert quantities are improved. In order that the lightweight rotogravure printing cylinders (100) developed within the scope of the invention can print with the same printing quality as the current cylinders with a high wall thickness, ribs (3), which are supporting parts, are placed inside the seamless tube so as to contact the inner surface of the cylindrical body (1) and are spaced apart along the length of the cylindrical body (1), thereby making the cylinders rigid. These ribs (3), which are placed or mounted therein, ensure that the lightweight rotogravure printing cylinders (100) are prevented from being deformed during their mounting to the printing machine bench by means of the shaft passed through the center of the cylindrical body (1).

Within the scope of the invention, the ribs (3), which are used to support the cylindrical form of the cylindrical body (1), are in circular form ensuring 360° contact with the inner walls of the cylindrical body (1) in the area they are placed. Therefore, possible vibrations, mechanical difficulties and surface defects that could not be eliminated in the state of the art and that may occur in production processes are avoided and it is enabled that the cylindrical body (1) is produced in a low wall thickness range. The lightweight rotogravure printing cylinders (100) of the present invention, which are produced with ribs (3), provide advantageous and faster printing with technical superiority without any problems under the working conditions they are exposed to during printing, as well as reduction in maintenance costs is achieved.

1. A lightweight rotogravure printing cylinder comprising:
at least one body which has a hollow cylindrical form and inlets at both ends of the lateral surface of the cylindrical form that are open so as to allow access to the inner volume, and wherein
at least one cover which enables to close the open inlets of the cylindrical body and to form a closed cylindrical form,
at least one shaft opening that allows grasping the shaft which enables the cylindrical body to be placed on the printing machine and rotational movement to be transferred therethrough, when it is passed through the center of the cylindrical body; and
at least one rib in the form of a circular plate which is spaced apart along the length of the cylindrical body extending between the covers, and enables the middle section of the cylindrical body remaining between the at least one cover to be supported from its inner surface, and has a shaft opening of a size that allows the shaft to pass through the center thereof.

2. The lightweight rotogravure printing cylinder according to claim 1, wherein the wall thickness of the steel plate material used to form the body is 3.5-7.5 mm.

3. The lightweight rotogravure printing cylinder according to claim 1, wherein the distance (L) between two consecutive ribs is in the range of minimum 1 cylinder diameter (D) and maximum 2 cylinder diameters (D).

4. The lightweight rotogravure printing cylinder according to claim 1, wherein ribs are positioned such that there will be at least 2 of them for each 1 meter of length along the length of the cylindrical body.

5. The lightweight rotogravure printing cylinder according to claim 1, wherein at least 3 ribs are positioned at equal intervals inside the cylindrical body.

6. The lightweight rotogravure printing cylinder according to claim 1, wherein the wall thickness of the rib enabling the cylindrical body to be supported from its inner surface is a maximum of 5 mm.

7. The lightweight rotogravure printing cylinder according to claim 1, wherein ribs are welded to the inner walls of the cylindrical body with a circumferential welding method (Mig-Mag method).
